(19) United States
(12) Patent Application Publication
(10) Pub. No.: US 2013/0317885 A1
(43) Pub. Date: Nov. 28, 2013

(54) METHOD OF TRACKING CONSIGNMENTS DURING THEIR PRODUCTION AND APPARATUS FOR PRODUCING A PLURALITY OF CONSIGNMENTS

(71) Applicant: BOEWE SYSTEC GmbH, Augsburg (DE)

(72) Inventor: Wolfgang MEINELT, Augsburg (DE)

(73) Assignee: BOEWE SYSTEC GmbH, Augsburg (DE)

(21) Appl. No.: 13/875,710

(22) Filed: May 2, 2013

(30) Foreign Application Priority Data
May 2, 2012 (DE) 102012207289.6

(51) Int. Cl. G06Q 30/02

(52) U.S. Cl. CPC G06Q 30/0202
USPC 705/7.31

(57) ABSTRACT

In a method of tracking consignments during their production by one or more processing plants, a plurality of original orders are provided, each of the original orders including a plurality of consignments to be produced. Depending on predetermined properties of the consignments, at least one processing order is produced, the processing order including at least one consignment which is to be produced and stems from different original orders. The processing order is processed by the one or more processing plants so as to produce the respective consignments from the original orders. Each consignment which is to be produced and is contained in the original orders is unambiguously associated with the corresponding consignment in the processing order so as to enable, on the basis of the association, tracking of a consignment from the original order while it is being processed.

### CROSS-REFERENCE TO RELATED APPLICATIONS

This application claims priority from German Patent Application No. 102012207289.6, which was filed on May 2, 2012, and is incorporated herein in its entirety by reference.

The present invention relates to a method of tracking consignments during their production by one or more processing plants as well as to an apparatus for producing a plurality of consignments. In particular, the present invention relates to an approach to consignment tracking of individual consignments from one or more orders, which—for the purpose of optimizing processing by one or more processing plants—have been subdivided into one or more processing orders for execution by the processing plant.

### BACKGROUND OF THE INVENTION

Paper-handling plants known in conventional technology have been used for producing, e.g., a consignment including one or more printed pages on the basis of input data which has been provided, for example by printing the corresponding individual sheets, which are then inserted into envelopes, possibly with further added inserts, and sorted and subsequently forwarded to a receiver. A service provider, a so-called mailroom service, may operate one or more of such processing plants so as to execute orders placed by different clients. Such orders include the information that may be used for producing the consignments on the part of the service provider, who obtains the information from the customer in an electronic form, for example, produces the consignments and prepares them for dispatch to the receiver. The orders received from one or more clients contain different consignments, i.e. consignments which differ with regard to their imprints, the number of sheets and the like, so that the service provider combines orders from different clients for processing by a processing plant which is either well suited for processing said orders or may be adjusted accordingly. Other orders are also newly combined and provided to the processing plant, which is then readjusted accordingly, or said other orders are provided to a different, suitable processing plant. In this manner, optimum exploitation of the processing plants is ensured. In addition, provision may be made for combining and processing orders from the different clients who indicate, as the receivers, the same destination area, e.g. the same zip code area, which makes sorting following enveloping superfluous.

Thus, due to the optimization in the processing of consignments and their dispatch, it is desirable to combine the orders received from the different clients as much as possible. The printers used in the above-mentioned processing plants enable full-color printing, so that the consignments of different clients may be combined on a roller since now the corresponding letterheads, if desired, may be produced for the different clients. Even during printing of an envelope there is the possibility of printing company logos or advertising onto a white envelope so as to produce, while executing an order, also the envelope that may be used in an customized manner, in addition to the individual sheets to be produced. On the side of the service provider, this enables simplification of logistics since in this case, only white paper and white envelopes need to be kept in stock. Further potential for savings results during production of the consignments themselves, namely when a maximum number of consignments may be manufactured in one go without any major changeover times. For example, consignments with large numbers of elements contained therein may be combined in one processing step in a manner spanning several orders. The need to separate the orders here results in most cases from the technical possibilities of the machines used in the processing plant. Another large potential for savings results from the optimization of the postage by suitably sorting the orders and by suitably selecting the supplier, possibly according to rules that apply on that particular day.

FIG. 1 schematically shows a so-called mailroom which is operated by a service provider and which includes a first processing plant 100 and a second processing plant 102, each of which includes a printer 100a, 102a as well as an enveloper 100b and 102b, respectively. The processing plants 100, 102 produce consignments forwarded to the respective receivers 104a, 104b, for example on the part of a supplier, which takes over the consignments produced by the plants 100, 102 and delivers them to the receivers 104a, 104b. The mailroom service provider receives from its clients 106a, 106b, 106c orders for producing consignments, respectively, such consignments typically including one or more printed individual sheets which are to be sent to the receivers 104a and 104b in an envelope, respectively. The orders of clients 106a and 106c contain the information that may be used for producing the individual sheets as well as information about the destination area, the envelopes to be used, and the like. The orders are received by the service provider at a controller 108 which includes a processing means 108, e.g. a computer, and a database 110. The orders received are checked and combined—with regard to optimization during processing and during dispatch of same—into one or more mixed print orders 111 which are optimized, e.g., with regard to processing and/or with regard to postage. For example, a first mixed print order may be produced for processing consignments on the part of the first processing plant 100, and a second mixed print order may be produced for processing the consignments contained therein on the part of the second processing plant 102. Alternatively, it is possible to produce—for a specific number of orders—a shared mixed print order whose data is forwarded either to the first processing plant 100 or to the second processing plant 102, depending on the optimization desired.

In the respective processing plants 100, 102, the consignment, in particular its individual sheets, is produced by the printers 100a, 102a on the basis of the data associated with the consignments in the mixed print order. The sheets produced are passed on to the enveloper 100b, 102b, which inserts the sheets produced into an envelope, possibly with further insets added prior to enveloping. The mail item produced is passed on to a supplier for delivery to the receiver 104a, 104b. On the basis of the information contained in the printing order, provision may further be made for individually printing on an envelope for a consignment and for providing it to the enveloper along with the individual sheets to be enveloped. In the event of an error occurring during enveloping, reprint of one or more of the consignments may be effected, as is indicated by arrows 112a, 112b, for example when the printing, enveloping or any other processing following the printing was faulty, so that the consignment was not fully or not correctly produced and therefore cannot be forwarded to the receiver.

The mixed print orders may contain, e.g., a first mixed print order which contains a plurality of consignments of different clients, each of who desires a first envelope size which may be processed by an enveloper in the plant 100. A second mixed printing order may contain, e.g., several consignments of the clients, but may use a smaller envelope format. This order may either be executed by the plant 100 once the latter has been adapted, or, if several plants are available, it may be passed on to the plant 102 which can process this size of envelope. Instead of producing two mixed print orders, the orders obtained from one or more clients may also be introduced into a shared mixed print order, the data of which is then passed on to the corresponding plants 100, 102 as a function of the envelope size.

Thus, optimized processing and/or optimized dispatch of consignments originating from orders of one or more clients may be achieved in the above-described manner.

Said above-described mixing of the consignments of the different orders of the clients makes it more difficult for a service provider, however, to communicate information about the status of an order to a customer, in particular information regarding the progress in the production of the individual consignments, their completion and quality.

### SUMMARY

According to an embodiment, a method of tracking consignments produced by one or more processing plants may have the steps of providing a plurality of original orders, each of said original orders including a plurality of consignments to be produced; depending on predetermined properties of the consignments, producing at least one processing order, said processing order including at least one consignment which is to be produced and stem from different original orders; and processing the processing order by the one or more processing plants so as to produce the respective consignments of the original orders; wherein each consignment in the original orders which is to be produced is unambiguously associated with the corresponding consignment in the processing order so as to enable tracking of a consignment of the original order during its processing on the basis of said association.

According to another embodiment, a method of tracking consignments produced by one or more processing plants may have the steps of: providing at least one original order which includes a plurality of consignments to be produced; depending on predetermined properties of the consignments, producing a plurality of processing orders, each of said processing orders including at least one consignment which is to be produced and stem from the original order; and processing the processing orders by the one or more processing plants so as to produce the respective consignments of the original order; wherein each consignment in the original order which is to be produced is unambiguously associated with the corresponding consignment in one of the processing orders so as to enable tracking of a consignment of the original order during its processing on the basis of said association.

According to another embodiment, a computer-readable medium may have a program code including instructions which, when the program code is performed by a computer, perform a method of tracking consignments produced by one or more processing plants, which method may have the steps of providing a plurality of original orders, each of said original orders including a plurality of consignments to be produced; depending on predetermined properties of the consignments, producing at least one processing order, said processing order including at least one consignment which is to be produced and stem from different original orders; and processing the processing order by the one or more processing plants so as to produce the respective consignments of the original orders; wherein each consignment in the original orders which is to be produced is unambiguously associated with the corresponding consignment in the processing order so as to enable tracking of a consignment of the original order during its processing on the basis of said association.

According to another embodiment, a computer-readable medium including a program code including instructions which, when the program code is performed by a computer, perform a method of tracking consignments produced by one or more processing plants, which method may have the steps of: providing at least one original order which includes a plurality of consignments to be produced; depending on predetermined properties of the consignments, producing a plurality of processing orders, each of said processing orders including at least one consignment which is to be produced and stem from the original order; and processing the processing orders by the one or more processing plants so as to produce the respective consignments of the original order; wherein each consignment in the original order which is to be produced is unambiguously associated with the corresponding consignment in one of the processing orders so as to enable tracking of a consignment of the original order during its processing on the basis of said association.

According to another embodiment, an apparatus for producing a plurality of consignments may have: one or more processing plants; and a controller effective to operate the one or more processing plants in accordance with the method of tracking consignments produced by one or more processing plants, which method may have the steps of: providing a plurality of original orders, each of said original orders including a plurality of consignments to be produced; depending on predetermined properties of the consignments, producing at least one processing order, said processing order including at least one consignment which is to be produced and stem from different original orders; and processing the processing order by the one or more processing plants so as to produce the respective consignments of the original orders; wherein each consignment in the original orders which is to be produced is unambiguously associated with the corresponding consignment in the processing order so as to enable tracking of a consignment of the original order during its processing on the basis of said association.

According to another embodiment, an apparatus for producing a plurality of consignments may have: one or more processing plants; and a controller effective to operate the one or more processing plants in accordance with the method of tracking consignments produced by one or more processing plants, which method may have the steps of providing at least one original order which includes a plurality of consignments to be produced; depending on predetermined properties of the consignments, producing a plurality of processing orders, each of said processing orders including at least one consignment which is to be produced and stem from the original order; and processing the processing orders by the one or more processing plants so as to produce the respective consignments of the original order; wherein each consignment in the original order which is to be produced is unambiguously associated with the corresponding consignment in one of the processing orders so as to enable tracking of a consignment of the original order during its processing on the basis of said association.

### BRIEF DESCRIPTION OF THE DRAWINGS

Embodiments of the present invention will be detailed subsequently referring to the appended drawings, in which:

FIG. 1 shows a schematic representation of a known mailroom operated by a service provider;

FIG. 2 shows a schematic representation of a mailroom in accordance with an embodiment of the invention;

FIG. 3 shows a flowchart of the method in accordance with an embodiment of the invention;

FIG. 4 shows an example of the association of references between original orders and mixed print orders, FIG. 4(a) showing an example of a consignment list for the original orders, and FIG. 4(b) showing a consignment list for the mixed print orders;

FIG. 5 shows examples of associations of the consignments in the original orders with the consignments in the mixed print orders, FIG. 5(a) showing the consignment list of FIG. 4(a), which has been supplemented by an identification list and a reference list, and FIG. 5(b) showing the consignment list, supplemented accordingly, for the mixed print orders; and

FIG. 6 shows a schematic representation of a mailroom in accordance with a further embodiment of the invention.

### DETAILED DESCRIPTION OF THE INVENTION

Embodiments of the invention will be explained in more detail below with reference to the accompanying figures, wherein elements in the drawings which are identical or have identical functions are provided with the same reference numerals.

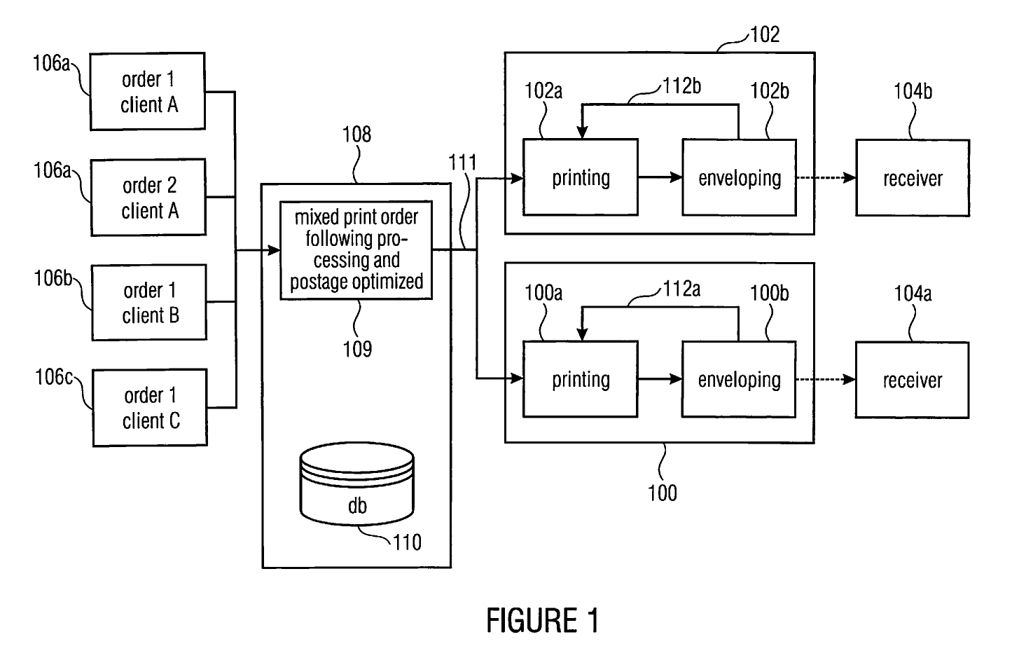

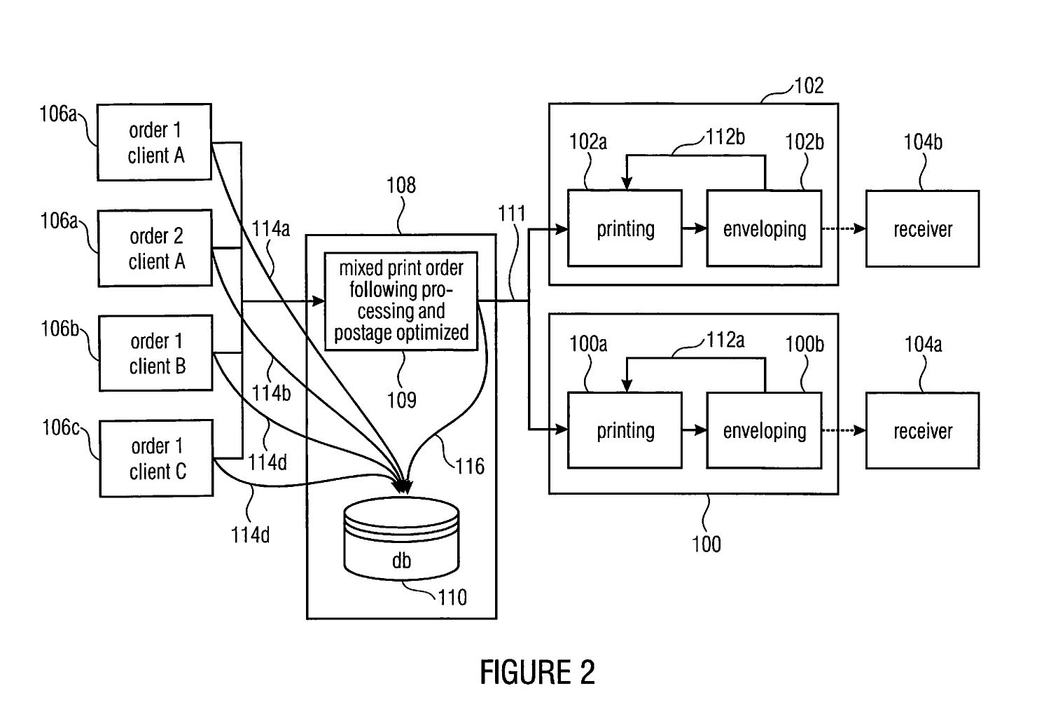

FIG. 2 shows a schematic representation of a mailroom as is provided, for example, by a service provider, similarly to the arrangement shown in FIG. 1. According to the invention, the orders provided by the clients 106a-106c are received at the controller 108, and consignment lists of the corresponding orders are provided to the database 110, as is illustrated by arrows 114a-114d. The processing means 109 of the controller 108 produces the mixed print order 111, and a consignment list for the mixed print order 111 is provided to the database 110, as is indicated by the arrow 116. The gap that was described above in connection with FIG. 1 and results from the subdivision of the consignments from the different client orders into one or several mixed print orders is avoided according to the invention in that any consignment to be produced and showing up in the incoming orders is unambiguously associated with a corresponding consignment in a mixed print order or processing order 111. For example, this is performed by means of references between the incoming orders and the associated consignment as well as the optimized processing unit, for example while using a modified consignment number noted down in a reference table and associated with the original order via said reference table. This association between the consignment from the original order and the consignment in the mixed print order enables that the current processing status may be mapped to the original order for each consignment at any time. Even if consignments from different orders of a client are packed into one envelope, this will be detected and can be taken into account in the corresponding feedback. If the consignments are tracked as far as to the receiver, or if the production of individual consignments is delayed due to reprints, this will also be detected and mapped accordingly in the progress report.

For the service provider, there is the possibility of further savings since it is now readily possible to distribute the received consignments across the processing plants in an optimum manner since the clients can be informed about the progress at any time, so that there is the possibility of passing on the savings which have been achieved by said optimization to the customers.

Thus, in accordance with embodiments of the invention, the controller 108 combines the received original orders or print orders from the viewpoints of optimization of processing, e.g. in terms of envelope size, postage, material and the like, so as to produce one or more new print orders, the so-called processing orders or mixed print orders. Both the original orders and the mixed print order contain consignments, corresponding consignment lists being handed over to the controller 108, as is indicated by arrows 114 and 116, and it is within the controller 108 that the above-mentioned association of the consignments in the original orders and in the mixed print order is effected, so that the consignments in the mixed orders, which may be tracked by the controller 108, may be associated with the corresponding original orders via the controller 108, which enables determining the progress with regard to processing of the individual consignments.

According to the invention, an approach is thus provided which enables trackability of client orders even in multi-stage production methods with reprint and optimization of the orders in terms of processing and dispatch criteria; it is particularly advantageous that the progress in terms of execution of the original orders or original print orders may be readily determined, that tracking of consignments from the original orders is possible while the processing plants are optimized, for example with regard to material costs. Thus, embodiments enable determining the number of consignments actually processed from the original order on the basis of the unambiguous association, so that recalculation of postage or material costs for the clients is enabled, or, specifically, so that precise settlement of only those consignments that were actually produced is enabled.

In accordance with a further embodiment, the consignments from one or more original orders may be combined while taking into account specifications of a delivery service, e.g. to obtain a reduction in postage for delivery to the receivers. For example, the consignments from one or more original orders may be combined in accordance with the destination areas (e.g. in accordance with the zip codes or part of the zip codes of the receiver addresses) and be processed together, so that no sorting by delivery area will be required at the delivery service, which will result in a reduction in the postage for the consignments. Alternatively, it is also possible to combine consignments of equal sizes or equal weights, so that sorting by size or by weight may be effected at the delivery service, which will also lead to a reduction in the postage on the part of the delivery service due to the reduced expenditure involved in processing said consignments on the part of the delivery service. Due to the inventive association of the combined consignments with the consignments in the one or the several original orders, the above-mentioned reductions may now also be associated with each consignment in the original order.

The embodiment described by means of FIG. 2 was explained in connection with a mailroom service provider; it shall be noted, however, that the present invention is not limited to this field of application. Rather, the inventive approach may also be employed in the event of utilizing one or more processing plants within one company, for example within a bank or an insurance corporation. In this case, the processing plant or the several processing plants receive different in-house orders which may be combined into a mixed print order so as to optimize processing of the different in-house orders, again with regard to the possibilities of application of the available processing plants and/or with regard to the destination area to which the consignments are directed. This, too, results—in in-house application—in an optimization of the resources while simultaneously offering the possibility of tracking the individual consignments during processing despite the individual orders having been mixed.

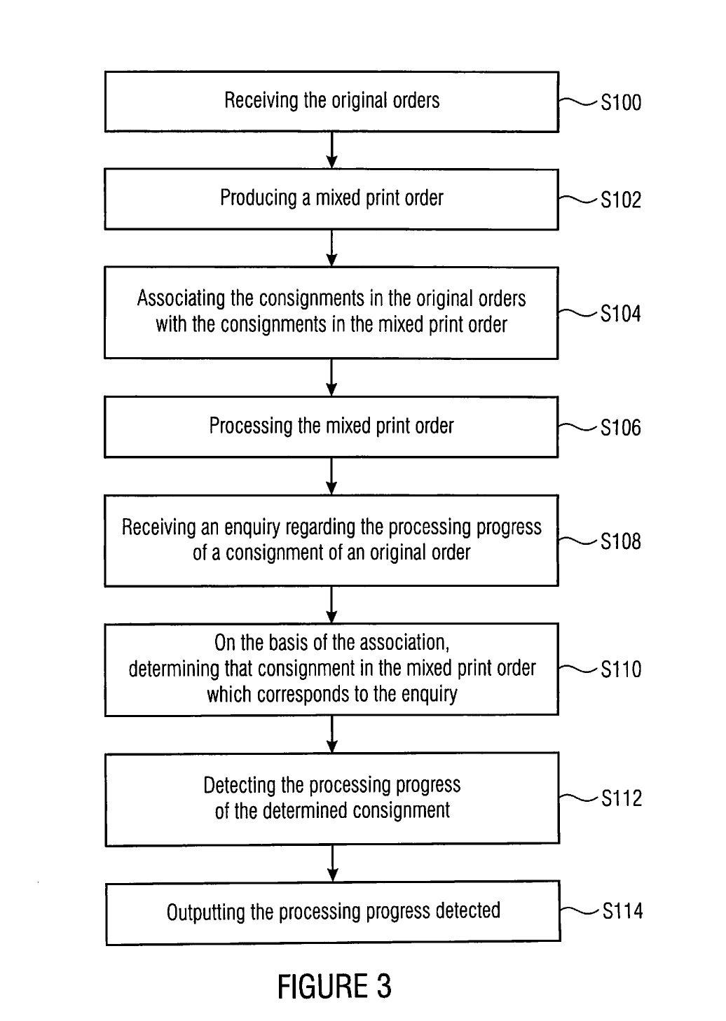

An embodiment of the inventive method will be explained in more detail with reference to FIG. 3. In step S100, one or more orders 105a-105c, the so-called original orders, are received, each order defining a plurality of consignments that are to be produced and forwarded to a receiver 104a, 104b. The consignments contain data defining the consignment to be produced and forwarded, for example the data to be printed on, information about the size of the individual sheets to be used or of the envelopes to be used, imprints on the envelope, and the like. The consignments contained in the different original orders are provided to the controller 108, and in step S102 the received consignments from the original orders are combined in one or more mixed print orders for the purpose of optimizing processing and/or shipment thereof; for the purpose of the description which follows it shall be assumed that the consignments obtained from the received envelope orders are combined into a mixed print order. Similarly to the consignment lists concerning the original orders, the consignment list concerning the mixed print order is provided to the database 110, and in addition, the controller 108 associates the consignments in the original orders with the consignments in the mixed print order, for example by associating corresponding references or identifications with each consignment in the original order and by associating a corresponding identification with the corresponding consignment in the mixed print order, as is shown in step S104.

As an alternative to the above-described approach, provision may be made, in accordance with embodiments, for only one original order to be obtained which includes several consignments to be produced, e.g. consignments of different sizes. In this case, the consignments are distributed across several processing orders, e.g. as a function of the sizes of the consignments, and processed. In this case, too, the consignments are associated with the consignments in the mixed processing orders in the above-described manner.

In addition, in accordance with further embodiments, provision may be made for subdividing a consignment from the original order during the processing thereof, e.g. if the number of sheets of the consignment exceeds the number that can be handled by the processing plant, e.g. the maximum number of sheets that can be processed simultaneously by a folding unit or a collecting station. In such a case, the consignment in the mixed processing order is subdivided into two or more consignments (partial consignments). Just like the non-subdivided consignments, the subdivided consignments are associated with their corresponding consignment in the original order (each partial consignment is associated with the corresponding consignment in the original order).

Subsequently, step S106 comprises processing of the mixed print order in that the mixed print order is provided to one or more of the processing plants 100, 102 for producing the individual consignments.

During execution of the mixed print order, a customer may wish to be informed about the progress of execution of their order or of a consignment of an original order, and a corresponding enquiry is received in step S108. In response to the enquiry in step S108, step S110 comprises access to the controller 108 so as to localize the corresponding consignment in the mixed print order on the basis of the information of the customer about the consignment in the original order. In step S112, the processing progress of this consignment is detected, and it is output to the enquiring client in step S114. For example, the processing progress may indicate that processing of the consignment has not yet started, that the consignment is being processed, or that processing has already been completed. Instead of enquiring about the processing state of individual consignments, the customer may also enquire about the processing progress of the overall order. The processing progress of the original order is obtained in that the processing progress of the corresponding consignments in the mixed print order is detected, combined and communicated to the customer for the consignments of the original order via the references associated with the latter. Said customer may gather from the information obtained which of the consignments has not yet been processed, which are being processed, and for which processing has already been completed. With regard to the consignments that are being processed, the stage of processing thereof may also be indicated, for example whether the consignment is being printed or enveloped or is just leaving the enveloper.

In the event of further tracking up to the receiver, this information, too, may be passed on to the customer.

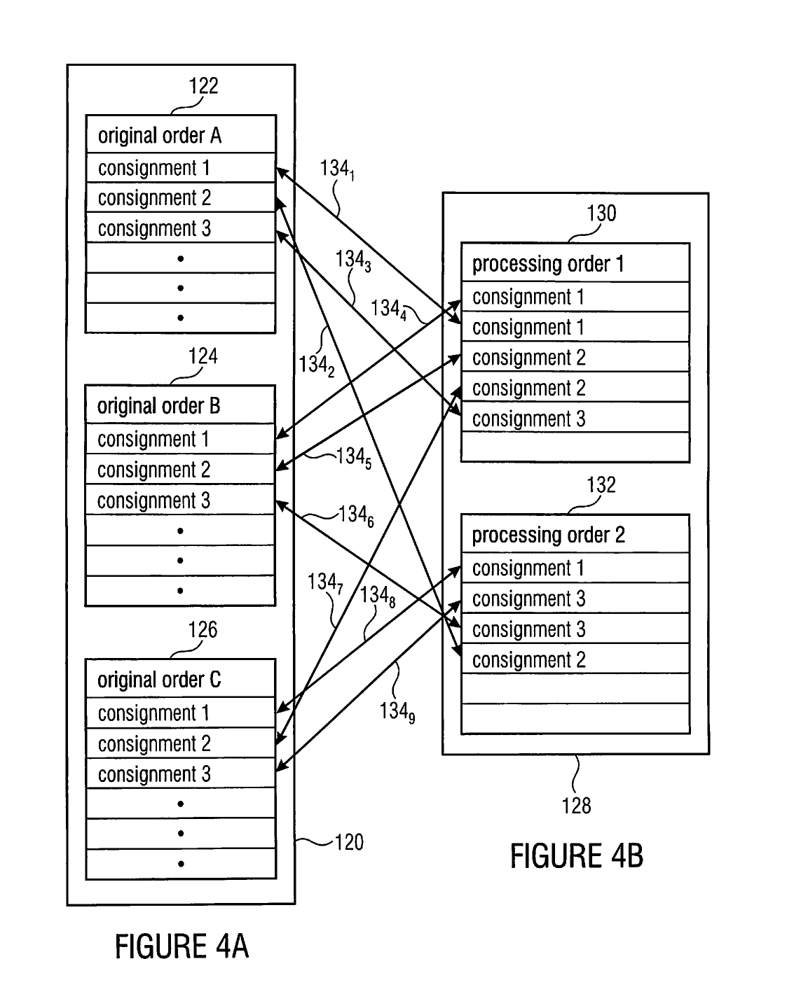

An example of associating references between original orders and processing orders and/or mixed print orders will be explained in more detail below with reference to FIG. 4. FIG. 4(a) shows an example of consignment lists handed over to the database 110 for the original orders. The consignment list 120 shown in FIG. 4(a) includes a sub-list 122 concerning a first order (original order A) and the further sub-lists 124, 126 containing the consignments of the original orders B and C. The corresponding consignments, which for simplicity's sake are represented as consignments 1 to 3, are listed in the sub-lists 122 to 126 in each case. FIG. 4(b) shows the consignment list 128 for the mixed print orders, which is provided by the processing means 109 of the controller 108 to the database 110 and includes a first sub-list 130 for a first mixed print order and a second sub-list 132 for a second mixed print order. Depending on the circumstances, it is also possible, as was already mentioned above, to produce only one mixed print order, which will then contain information for the production of the consignments by different processing plants. In this case, the consignment list 128 will contain one sub-list only. The first mixed print order (processing order 1) contains consignments from the different original orders, which have been combined in this processing order 1 in accordance with the above-described criteria with regard to optimum processing and/or with regard to optimum dispatch. The second processing order includes consignments from the different original orders combined in accordance with other criteria. According to the invention, the lists 120 and 128 provided to the database 110 are linked, as is shown by arrows 134, so that the consignments contained in the corresponding processing orders 1 and 2 are associated with the consignments in the original orders A to C. The references in FIG. 4 are schematically depicted by arrows 134₁ to 134₉. Thus, e.g., unambiguous association of the consignment 1 in the original order A with the corresponding consignment in the processing order 1 results, as is indicated by arrow 134₁. Similarly, corresponding association of the remaining consignments in the original orders results.

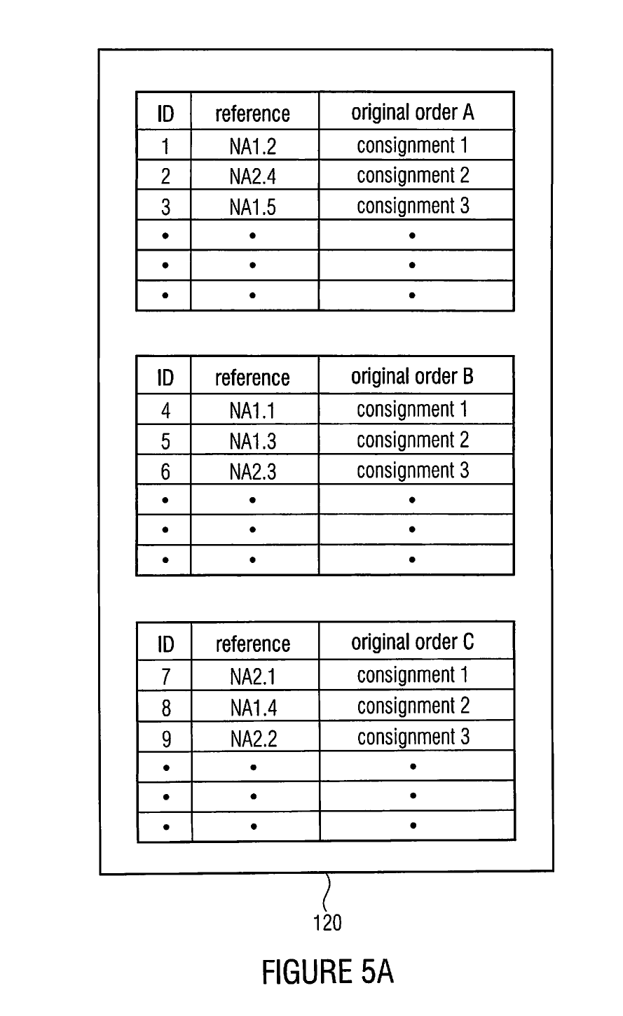

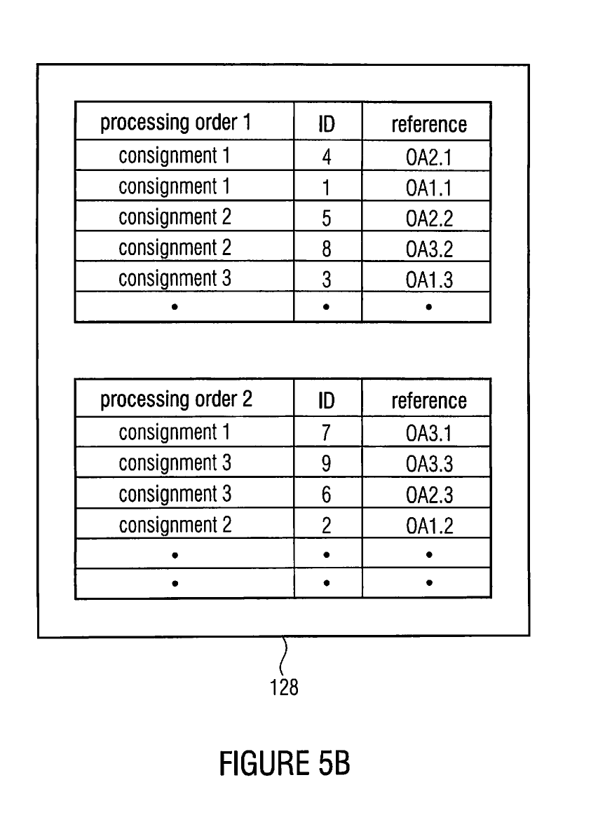

FIG. 5 shows examples for possible associations of the consignments in the original orders with the consignments in the processing orders. FIG. 5(a) shows the consignment list 120 for the original orders which is stored in the database 110 and has been supplemented by an identification list in accordance with a first embodiment or by a reference list in accordance with a second embodiment. FIG. 5(b) shows the consignment list 128 for the mixed print orders which has been supplemented accordingly. In accordance with the first embodiment, provision is made, in FIG. 5(a), for each consignment in the original orders which are received by the controller 108 to have an unambiguous identification associated with it, for example the identification numbers 1 to 9. The controller 108 is configured to associate those identification numbers which are associated with the consignments of the original orders with the corresponding consignments in the processing orders on the basis of the received original orders and on the basis of the received mixed orders, as is shown in FIG. 5(b). In this manner, the consignments in the original orders are associated with the corresponding consignments in the processing orders, as is depicted in FIG. 4 by the arrows.

In accordance with the second embodiment, provision is made for associating a corresponding position in one of the processing orders with each consignment in an original order and for associating the corresponding position in the original orders with the consignments in the processing orders. By way of example, let us look at the consignment 1 in the original order A in the consignment list 120. Its reference is NA1.2, which means that this consignment corresponds to the consignment located at the second position in the processing order 1. Corresponding references are found for the remaining consignments.

Accordingly, the second entry in the processing order 1 of the consignment list 128 contains the reference OA1.1, which means that the consignment 1 at this position corresponds to the consignment at the position 1 in the original order 1.

Thus, it is possible to track the entire original order or individual consignments thereof via the above-described references since the association is unambiguous and may be called up at any time via the lists shown.

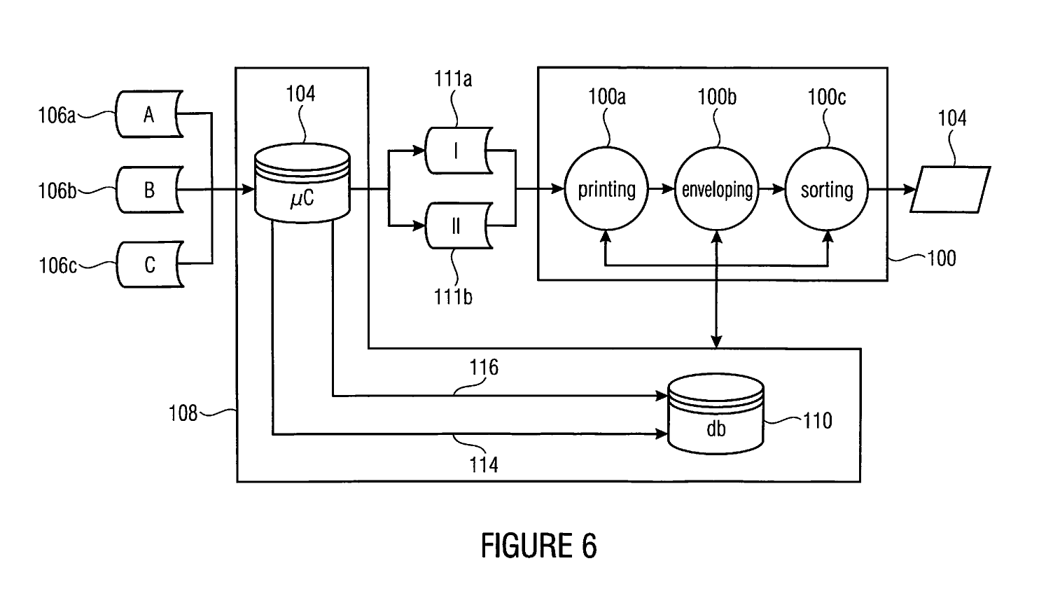

By means of FIG. 2, an example was described wherein several processing plants are provided for which a shared mixed print order is provided. FIG. 6 shows a further embodiment of a mailroom service provider by means of a schematic representation. Similarly to FIG. 1, different orders 106a-106c are received at the controller 108, and it is via a corresponding processing station 109 that mixed print orders 111a and 111b are produced in accordance with predetermined criteria, as was explained above. Via the apparatus 109, the consignment lists for the original orders and for the mixed print orders are passed on to the database 110, as is indicated by arrows 114 and 116. In the above-described manner, the consignments in the different lists are mutually associated with one another. As has been mentioned, in the embodiment shown in FIG. 6, two mixed print orders 118a and 118b are produced which were drawn up in accordance with different criteria, for example in order to ensure optimum arrangement of the individual sheets to be produced on a paper web produced by the printer 100a of the processing plant 100. The paper web may be provided to the printer 100a in the form of a roller, for example, which printer 100a will then print upon the paper web in accordance with the mixed print orders. The paper web may then be provided to the remaining components of the processing plant in an online or offline manner, for example to the enveloper 100b, which singularizes the individual sheets located on a printed roller, groups together the individual sheets to form the desired consignments, and envelopes them. If it is desired, sorting may subsequently take place. Alternatively, instead of arranging the individual sheets on a paper web in an optimized manner, a single sheet printer 100a may also be activated, so that the effected individual sheets are provided to the subsequent processing plants in an optimum manner during online operation.

In the embodiment shown in FIG. 6, two mixed print orders 118a and 118b are produced, as has been mentioned; in accordance with the embodiment presented, the first print order 118a is initially provided to the arrangement 100 adjusted accordingly, and the consignments thus produced are forwarded to the receiver 104. Once the first mixed print order 118a has been executed, the plant 100 is adapted for processing the consignments in accordance with the mixed print order 118b, and said print order is processed by the plant 100. In accordance with further embodiments, in accordance with which one or more additional processing plants are provided, the mixed print orders 118a and 118b may also be processed in parallel.

As may further be seen in FIG. 6, the controller 108 further serves to control the individual components of the processing plant 100, as is depicted by the corresponding arrows.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A method of tracking consignments produced by one or more processing plants comprising:
providing a plurality of original orders, each of said original orders comprising a plurality of consignments to be produced;
depending on predetermined properties of the consignments, producing at least one processing order, said processing order comprising at least one consignment which is to be produced and stem from different original orders; and
processing the processing order by the one or more processing plants so as to produce the respective consignments of the original orders;
wherein
each consignment in the original orders which is to be produced is unambiguously associated with the corresponding consignment in the processing order so as to enable tracking of a consignment of the original order during its processing on the basis of said association.

2. A method of tracking consignments produced by one or more processing plants comprising:
providing at least one original order which comprises a plurality of consignments to be produced;
depending on predetermined properties of the consignments, producing a plurality of processing orders, each of said processing orders comprising at least one consignment which is to be produced and stem from the original order; and
processing the processing orders by the one or more processing plants so as to produce the respective consignments of the original order;
wherein
each consignment in the original order which is to be produced is unambiguously associated with the corresponding consignment in one of the processing orders so as to enable tracking of a consignment of the original order during its processing on the basis of said association.

3. The method as claimed in claim 1, wherein said associating comprises:
associating an unambiguous identification with each consignment in an original order, and associating the unambiguous identification with the corresponding consignment in a processing order.

4. The method as claimed in claim 1, wherein said associating comprises:
associating a first unambiguous identification with each consignment in an original order, said first unambiguous identification identifying that consignment in a processing order which corresponds to a consignment in the original order, and/or associating a second unambiguous identification with each consignment in a processing order, the second unambiguous identification identifying that consignment in an original order which corresponds to a consignment in the processing order.

5. The method as claimed in claim 3, wherein the identification is printed onto the consignment produced during processing, or wherein the identification is associated with a consignment ID which is associated with the consignment produced by the processing.

6. The method as claimed in claim 3, wherein said associating comprises storing the original order, the processing order, and the identifications in a controller, said controller being accessed for tracking a consignment.

7. The method as claimed in claim 1, wherein tracking of a consignment indicates whether processing thereof has begun, whether it is being processed or whether its processing has been completed.

8. The method as claimed in claim 7, wherein a processing progress is indicated during processing of the consignment.

9. The method as claimed in claim 1, wherein each of the consignments defines one or more printed sheets to be produced, each printed sheet with which a dimension and printing data are associated.

10. The method as claimed in claim 1, wherein a processing order is produced such that a processing plant used for producing the consignments operates in an optimum manner.

11. The method as claimed in claim 1, wherein consignments from the original order which are equal in size, in postage, in material and/or in destination area are combined into a processing order.

12. The method as claimed in claim 11, wherein producing a processing order comprises producing several printing flows so as to produce printed sheets for the consignments in such a manner that the printed sheets are arranged in an optimum manner on a paper web provided to the processing plant, or that the printed sheets are produced by an individual printer in an optimum sequence for processing by the processing plant.

13. The method as claimed in claim 1, wherein said processing of a processing order comprises printing, enveloping, sorting and/or franking.

14. The method as claimed in claim 1, wherein processing a processing order comprises printing the consignment and subsequently processing the consignment; in the event that printing or subsequent processing of the consignment is faulty, reprinting of the consignment is performed, the identification associated with the faulty consignment being associated with the new consignment in response to the reprint, so that unambiguous association of the new consignment with the corresponding consignment in the original order is maintained.

15. The method as claimed in claim 1, wherein the number of consignments actually processed from the original order is determined on the basis of the unambiguous association.

16. The method as claimed in claim 1, wherein a plurality of processing plants is provided so as to process two or more processing orders in parallel.

17. The method as claimed in claim 1, wherein the processing plant is operated by a service provider receiving the original orders from different customers.

18. The method as claimed in claim 1, wherein a plurality of original orders is provided, wherein one or more processing orders are produced, and wherein a processing order comprises consignments for processing by one or more processing plants.

19. The method as claimed in claim 1, wherein producing a processing order comprises subdividing one or more consignments from an original order into several partial consignments, said several partial consignments being unambiguously associated with the corresponding consignment in the original order.

20. A computer-readable medium comprising a program code comprising instructions which, when the program code is performed by a computer, perform a method of tracking consignments produced by one or more processing plants, said method comprising:
providing a plurality of original orders, each of said original orders comprising a plurality of consignments to be produced;
depending on predetermined properties of the consignments, producing at least one processing order, said processing order comprising at least one consignment which is to be produced and stem from different original orders; and
processing the processing order by the one or more processing plants so as to produce the respective consignments of the original orders;
wherein
each consignment in the original orders which is to be produced is unambiguously associated with the corresponding consignment in the processing order so as to enable tracking of a consignment of the original order during its processing on the basis of said association.

21. A computer-readable medium comprising a program code comprising instructions which, when the program code is performed by a computer, perform a method of tracking consignments produced by one or more processing plants, said method comprising:
providing at least one original order which comprises a plurality of consignments to be produced;
depending on predetermined properties of the consignments, producing a plurality of processing orders, each of said processing orders comprising at least one consignment which is to be produced and stem from the original order; and
processing the processing orders by the one or more processing plants so as to produce the respective consignments of the original order;
wherein
each consignment in the original order which is to be produced is unambiguously associated with the corresponding consignment in one of the processing orders so as to enable tracking of a consignment of the original order during its processing on the basis of said association.

22. An apparatus for producing a plurality of consignments, comprising:
one or more processing plants; and
a controller effective to operate the one or more processing plants in accordance with the method of tracking consignments produced by one or more processing plants, said method comprising:
providing a plurality of original orders, each of said original orders comprising a plurality of consignments to be produced;
depending on predetermined properties of the consignments, producing at least one processing order, said processing order comprising at least one consignment which is to be produced and stem from different original orders; and
processing the processing order by the one or more processing plants so as to produce the respective consignments of the original orders;
wherein
each consignment in the original orders which is to be produced is unambiguously associated with the corresponding consignment in the processing order so as to enable tracking of a consignment of the original order during its processing on the basis of said association.

23. An apparatus for producing a plurality of consignments, comprising:
one or more processing plants; and
a controller effective to operate the one or more processing plants in accordance with the method of tracking consignments produced by one or more processing plants, said method comprising:
providing at least one original order which comprises a plurality of consignments to be produced;
depending on predetermined properties of the consignments, producing a plurality of processing orders, each of said processing orders comprising at least one consignment which is to be produced and stem from the original order; and
processing the processing orders by the one or more processing plants so as to produce the respective consignments of the original order;
wherein
each consignment in the original order which is to be produced is unambiguously associated with the corresponding consignment in one of the processing orders so as to enable tracking of a consignment of the original order during its processing on the basis of said association.
